(19) United States
(12) Patent Application Publication
(10) Pub. No.: US 2026/0084932 A1
(43) Pub. Date: Mar. 26, 2026

(54) ELEVATOR CONSTRUCTION ARRANGEMENT AND METHOD

(71) Applicant: KONE Corporation, Helsinki (FI)

(72) Inventors: Mika Ijäs, Helsinki (FI); Matti Räsänen, Helsinki (FI); Mikko Kukkola, Helsinki (FI); Markku Haapaniemi, Helsinki (FI)

(73) Assignee: KONE Corporation, Helsinki (FI)

(21) Appl. No.: 19/407,651

(22) Filed: Dec. 3, 2025

Related U.S. Application Data
(63) Continuation of application No. PCT/EP2023/065519, filed on Jun. 9, 2023.

(51) Int. Cl. B66B 7/10; B66B 11/00; B66B 19/02

(52) U.S. Cl. CPC B66B 7/10; B66B 11/008; B66B 19/02

(57) ABSTRACT

An elevator construction arrangement includes: a hoistway; an elevator car, a counterweight, car guide rails, and counterweight guide rails; an elevator hoisting machinery and a high friction coated suspension roping mounted on first and second rope suspenders and arranged to suspend the car and the counterweight during construction time use; a protection deck mounted within the hoistway during an elevator jump operation in the hoistway; a hoist device configured to move the car or at least parts of the car below the protection deck, the car being guided on the car guide rails. The arrangement includes, arranged on top of the car, a first folding pulley beam with first folding pulleys having a small or reduced diameter, and a smaller bending radius of the high friction coated suspension roping is adapted to cooperate with the small or reduced diameter of the first folding pulleys.

### FIELD OF THE INVENTION

The invention relates to an elevator construction arrangement and a method for installing an elevator during construction of a building.

### BACKGROUND OF THE INVENTION

The construction of an elevator may especially in high-rise buildings be done in parts along the height of the elevator hoistway. Guide rails and landing doors may first be installed to a first height in the hoistway, then to a second height etc. As the construction of the building progresses, an elevator is wanted for use during the construction period. A construction time elevator may then be operated on the already installed lower portion of the hoistway while the construction of the elevator is going on in a higher portion of the hoistway.

In connection with so-called jump-lifts, the bottom portion of the hoistway is taken into use before the construction of the building has been completed. In this case the upper parts of the building as well as the top portion of the hoistway can be constructed at the same time as an elevator car moving in the bottom portion of the hoistway already serves people on the lower floors of the building under construction.

The elevator car moving in the lower portion of the hoistway may be supported and moved during construction-time use with a hoisting machinery supported on a guide rail mounted to a wall of the hoistway.

The elevator car may hang from the hoisting machinery suspended by a hoisting roping during its use for transporting passengers and/or goods below a protection deck mounted within the hoistway.

Construction work in the hoistway above the protection deck may be performed by working on an installation platform suspended from above and movable above the protection deck.

When the elevator hoistway under construction above the mounted hoisting machinery and the elevator car serving as a construction time use CTU car has reached a sufficient stage of completion, the completed portion of the hoistway can be taken into use. At this stage a jump is performed, wherein the hoisting machinery is hoisted higher in the hoistway.

By extending the elevator hoisting roping, moving the motor and control cabinets to a new machine room level, the travel length of the elevator during construction can be increased. So the elevator car can reach a higher position than before the jump and start to serve additional floors.

One time-consuming operation on current jump lifts is removing the steel ropes from under the car and from the motor and putting them back in place.

### SUMMARY OF THE INVENTION

The objective of the invention is to bring forward a solution for increasing elevator travel length during construction.

An object of the present invention is to present an improved elevator construction arrangement and an improved method for installing an elevator during construction of a building.

It is brought forward a new elevator construction arrangement comprising

a hoistway,

an elevator car, a counterweight, car guide rails for guiding the car, and counterweight guide rails for guiding the counterweight,

an elevator hoisting machinery and a high friction coated suspension roping mounted on first and second rope suspenders and arranged to suspend the car and the counterweight during construction time use,

a protection deck mounted within the hoistway during an elevator jump operation in the hoistway,

a hoist device configured to move the car or at least parts of the car below the protection deck, the car being guided on the car guide rails, wherein

the arrangement comprises, arranged on top of the car, a first folding pulley beam with first folding pulleys having a small or reduced diameter, and

a smaller bending radius of the high friction coated suspension roping is adapted to cooperate with the small or reduced diameter of the first folding pulleys.

According to an embodiment, the first folding pulley beam is mounted on the roof of the car.

According to an embodiment, the first folding pulley beam is mounted on a car sling, preferably on a car sling top beam.

According to an embodiment, a parallel first folding pulley beam is installed on the roof of the car, parallel with respect to a side of the car.

According to an embodiment, a skewed first folding pulley beam is installed on the roof of the car, inclined with respect to a side of the car.

According to an embodiment, the first folding pulleys are arranged at ends of the first folding pulley beam.

According to an embodiment, the first folding pulley beam is a construction time use CTU pulley beam.

According to an embodiment, the high friction coated suspension roping comprises PU-coated ropes or PU-coated belts.

According to an embodiment, the high friction coated suspension roping comprises car support means having a rectangular or a circular cross section.

According to an embodiment, the high friction coated suspension roping comprises a smaller bending/folding radius than a suspension roping without a high friction coating.

According to an embodiment, the high friction coated suspension roping is adapted to bend/fold around first folding pulleys with a smaller or reduced diameter compared to folding pulleys used with a suspension roping without a high friction coating.

According to an embodiment, the high friction coated suspension roping comprises a smaller thickness in direction of the radius of a first folding pulley having a reduced diameter than a suspension roping without a high friction coating.

According to an embodiment, the configuration of the first folding pulleys having a small or reduced diameter on top of the car provides for a safety clearance between the car and the wall of the hoistway, preferably without need of safety rails on top of the car.

According to an embodiment, a bottom second folding pulley beam with second folding pulleys at its ends is installed to the car bottom prior to inspection of the elevator for final elevator use transporting people and goods

According to an embodiment, the second rope suspender comprises a rope locking anchor enabling running of the roping through the second rope suspender.

According to an embodiment, the arrangement comprises a roping supply storage such as a rope reel to deliver the roping to the second rope suspender.

According to an embodiment, as the elevator travel is extended, the jump comprises a hoisting operation
of the machinery on the roof of the car into a headroom in the hoistway; and/or
of the first rope suspender on the roof of the car into a headroom in the hoistway; and/or
of the second rope suspender by a material hoist arranged on the protection deck.

According to an embodiment, the hoist device, supported by the protection deck, comprises a man riding hoist attachable to the car, and a hoist rope attachable to the car and movable with the hoist device during elevator installation.

According to an embodiment, headroom attachments to be moved upwards during jump are selected from a group comprising machinery supports; rope suspender brackets; guide rail brackets; overspeed governor brackets.

According to an embodiment, the elevator car is intended for the use of passengers during construction.

According to an embodiment, the protection deck comprises a material hoist configured to hoist construction material below the protection deck.

According to an embodiment, the car is configured to hoist guide rails and other heavy elevator components.

It is also brought forward a new method for installing an elevator during construction of a building in an arrangement as described above and/or hereinafter, wherein the method comprises, in connection with an elevator jump, arranging the high friction coated suspension roping via the first folding pulleys having a small or reduced diameter and arranged on top of the car.

According to an embodiment, the method comprises parking the car on a predefined level in the hoistway so that a technician has access to the machinery and the rope suspenders from the car roof.

According to an embodiment, the method comprises lightening the car by the hoist to take the weight off the roping.

According to an embodiment, the method comprises locking the roping from the machinery CWT side with a rope clamp and attaching the clamp to the second rope suspender.

According to an embodiment, the method comprises disconnecting the roping from the first rope suspender and sliding the roping off the first folding pulleys.

According to an embodiment, the method comprises moving the roping over the machinery so that the ropes are on the counterweight side.

According to an embodiment, the method comprises
moving the machinery on the roof of the car into a headroom in the hoistway; and/or
moving the first rope suspender on the roof of the car into a headroom in the hoistway; and/or
moving the second rope suspender by a material hoist arranged on the protection deck.

According to an embodiment, the method comprises placing the counterweight onto a support during the jump.

According to an embodiment, the method comprises moving the car by the hoist device supported by the protection deck.

According to an embodiment, the method comprises arranging the roping via second folding pulleys installed to the car bottom prior to inspection of the elevator for final elevator use transporting people and goods.

Typically, a set of folding pulleys for the elevator roping has been placed under the elevator car making the installation more difficult when a jump to the upper floors is made. Re-roping the car has required “pull cords” to install the ropes under the car. By the invention, the time-consuming steps of removing the steel ropes from under the elevator car and from the elevator motor and placing them back in place can be avoided.

The set of folding pulleys on the roof of the elevator car makes it much easier to re-rope the car in connection of the jump. When the folding pulley beam is placed on the roof of the car, this also enables a low pit.

The invention speeds up the extension of the elevator travel by making it easier to remove the elevator suspension ropes and belts from the car. Using for instance PU coated ropes and belts results in a smaller diameter of the folding pulley, so that the roping angle remains small enough in relation to the hoisting machinery traction sheave when the car is in the top floor.

The small diameter of the folding pulleys means that safety clearances required by elevator regulations are left on the car roof and no additional safety rails are needed on the roof of the car. The new method can partially replace the “pull cords”method.

The jumping time can be reduced to a minimum on site to meet customer demand. This means that finalized elevators can be handed over to the customer earlier.

### BRIEF DESCRIPTION OF THE DRAWINGS

The invention will in the following be described in greater detail by means of preferred embodiments with reference to the attached drawings, in which:

FIG. 1 shows a schematic view of an elevator in a hoistway,

FIG. 2 shows an arrangement for constructing an elevator during construction of a building using a working platform such as an elevator car as an installation platform in a bottom section of the hoistway,

FIG. 3 shows a machine-room-less elevator in construction time use in the bottom section of the hoistway,

FIG. 4 shows an upper section installation using an installation platform after extension of the elevator travel,

FIG. 5 shows a further section installation using the elevator car as an installation platform during extension of the elevator travel,

FIGS. 6a-6c show two embodiments of an elevator car equipped with a CTU pulley beam on top of the car, and

FIGS. 7a-7d show an elevator construction arrangement according to an embodiment in different phases of a method according to an embodiment.

### DETAILED DESCRIPTION

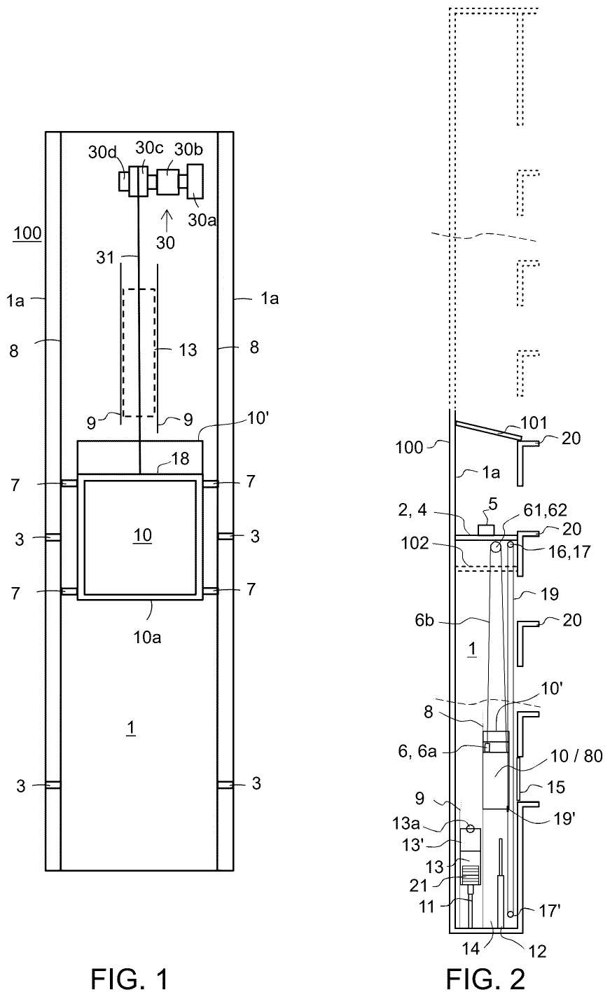

FIG. 1 shows a schematic view of an elevator.

The arrangement in FIG. 1 comprises a car 10, an elevator hoistway 1, a hoisting machinery 30, high friction coated suspension roping 31 such as PU-coated ropes or PU-coated belts, and a counterweight 13. A separate or an integrated car frame or sling 10a may surround the car 10.

According to an embodiment, the roping 31 comprises car support means having a rectangular or a circular cross section.

The hoisting machinery 30 may be positioned in the hoistway 1. The hoisting machinery may comprise a drive 30a, an electric motor 30b, a traction sheave 30c, and a machinery brake 30d. The hoisting machinery 30 may move the car 10 in a vertical direction upwards and downwards in the vertically extending elevator hoistway 1. The machinery brake 30d may stop the rotation of the traction sheave 30c and thereby the movement of the elevator car 10.

In FIG. 1, the car 10 is connected by the ropes 31 via the traction sheave 30c to the counterweight 13. The car and the counterweight are suspended by one or more ropes 31 which are guided over the traction sheave 30c for moving the car 10 vertically in the hoistway 1.

In FIG. 1, the car 10 is further supported with guide members 7 at car guide rails 8 extending in the vertical direction in the hoistway. The guide rails may be attached with guide rail brackets 3 to the side wall structures 1a in the hoistway. The guide members 7 ensure the vertical movement of the car 10 when the car moves upwards and downwards in the hoistway 1. The counterweight 13 is supported in a corresponding way on guide rails 9 that are attached to the wall structure 1a of the hoistway 1.

The car 10 may transport people and/or goods between landings 20 in a building 100. The elevator hoistway 1 may be formed so that the wall structure 1a is formed of solid walls or so that the wall structure 1a is formed of an open steel structure. A balustrade 10′may be installed on the car 10, at least during installation, providing safe working area on a roof 18 of the car 10.

FIG. 2 shows at an initial stage an arrangement for installing an elevator during construction of the building 100. A weather deck 101 and a temporary working deck 102 may be installed in the hoistway 1 preferably by the builder. The weather deck 101 may be an inclined waterproof deck which seals the hoistway 1 to keep it clean and dry.

For example from the working deck 102, the elevator installers may install a protection deck 2 for protecting the portion of the hoistway 1 below the protection deck from any possible falling objects.

According to an embodiment, the protection deck 2 may be used as a top protection deck which can provide at least some of the functions of the weather deck 101.

According to an embodiment, the protection deck 2 comprises a frame 4 mounted on walls 1a of the hoistway 1. According to an embodiment, the protection deck 2 comprises a cover co-operating with the frame and extending substantially horizontally across the hoistway 1. The cover is adapted to protect the hoistway 1 from falling objects and/or water from falling into the hoistway below it.

According to an embodiment, the protection deck 2 comprises a first lifting point supported by the frame 4. The first lifting point may be used for hanging an upper pulley 17 of an overspeed governor 16 OSG. An OSG rope 19 may be passed over the OSG upper pulley 17 and an OSG lower pulley 17′. The first lifting point may comprise a first attaching member supported by the frame 4 for example equipped with an eye/opening or a corresponding similar means of attachment for a hook or a corresponding gripping member for hanging the overspeed governor 16.

According to an embodiment, the protection deck 2 comprises a second lifting point supported by the frame 4. The second lifting point may be used for hanging a chain hoist. The chain hoist may be used for elevator hoisting machinery 30 hoisting. The second lifting point may comprise a second attaching member supported by the frame 4 for example equipped with an eye/opening or a corresponding similar means of attachment for a hook or a corresponding gripping member for hanging the chain hoist.

According to an embodiment, the arrangement comprises a first hoisting apparatus 6 also called a hoist device 6. The first hoisting apparatus 6 serves for hoisting an elevator car 10 or an installation platform 80, in FIGS. 2-5 supported by the protection deck 2.

According to an embodiment, the first hoisting apparatus 6 comprises a first hoisting machine 6a also called a man riding hoist 6a, and a first flexible tension member 6b also called a hoist rope 6b movable with the first hoisting machine 6a.

According to an embodiment, the arrangement comprises a hoisting point 61 configured to support the car 10 or the installation platform 80 in the hoistway via the first hoisting machine 6a and the first flexible tension member 6b.

According to an embodiment, the hoisting point 61 comprises a connecting member 61 supported by the frame 4 of the protection deck 2. According to an embodiment, a rotatable diverting pulley 62 is supported by a hook or a corresponding gripping member. The hook may be connected to the connecting member 61. The connecting member 61 may be equipped with an eye/opening or a corresponding similar means of attachment for the hook or said corresponding gripping member. The diverting pulley 62 serves for guiding and supporting the hoist rope 6b.

According to an embodiment, the protection deck 2 comprises a second hoisting apparatus 5 also called a material hoist 5, supported by the protection deck, for hoisting construction material below the protection deck. According to an embodiment, the material hoist comprises a second hoisting machine also called a material hoisting machine mounted on the protection deck 2, preferably on the frame 4 thereof, and a second flexible tension member also called a material hoist rope movable with the material hoisting machine.

The protection deck 2 with auxiliary equipment may be used as movable installation tool for hoisting of large loads such as: a movable machine room or hoisting machinery 30 of an elevator located below the protection deck 2 or an elevator car 10 or an installation platform 80 below the protection deck 2, and construction material such as guide rails 8, 9.

The first hoisting machine 6a may be mounted on the elevator car 10 and the flexible tension member 6b passes around the diverting pulley 62 connected to the hoisting point 61.

The material hoist 5 may be used to hoist car guide rails 8 and counterweight guide rails 9 and other heavy elevator components during the installation of the elevator.

Once the protection deck 2 is installed and the hoistway 1 is sealed, the elevator installation can start for the bottom section of the hoistway 1 below the protection deck 2.

While the elevator is installed at the bottom part of the building 100 in the hoistway 1, the building construction continues normally above it.

According to an embodiment, in the bottom section of the hoistway 1, car guide rails 8, counterweight guide rails 9, a counterweight buffer assembly 11, a car buffer assembly 12, a counterweight (CWT) 13 with a CWT pulley 13a and a CWT frame 13′filled partly with CWT fillers 21, and a working platform 10, 80 are installed in a pit 14. According to an embodiment, the working platform 10, 80 is then used as the installation platform, as shown in FIG. 2. The working platform is moved with the help of the man riding hoist 6a, utilizing the first hoisting point 61 of the protection deck 2. Landing doors 15 and other elevator hoistway components are installed in the elevator hoistway 1.

According to an embodiment the car 10 is installed inside the hoistway 1 to be guided by the car guide rails 8. The car 10 may be equipped with a car sling 10a having a top beam and a bottom beam. The OSG rope 19 may be fixed to the car by OSG rope terminals 19′ and guided around the upper 17 and lower 17′ OSG pulleys. A balustrade 10′ may be installed on the car 10. According to an embodiment, by the car 10 is meant at least parts of the car, such as a car sling 10a, which may be guided on the car guide rails 8.

According to an embodiment the working platform comprises the car with the car sling which is complemented by a platform such as a working deck for the installer. According to an embodiment the car is equipped with walls. According to an embodiment the car is a final car. According to an embodiment, the working platform comprises the car 10 or at least parts of the car to be guided on the car guide rails. According to an embodiment, the working platform comprises the installation platform 80.

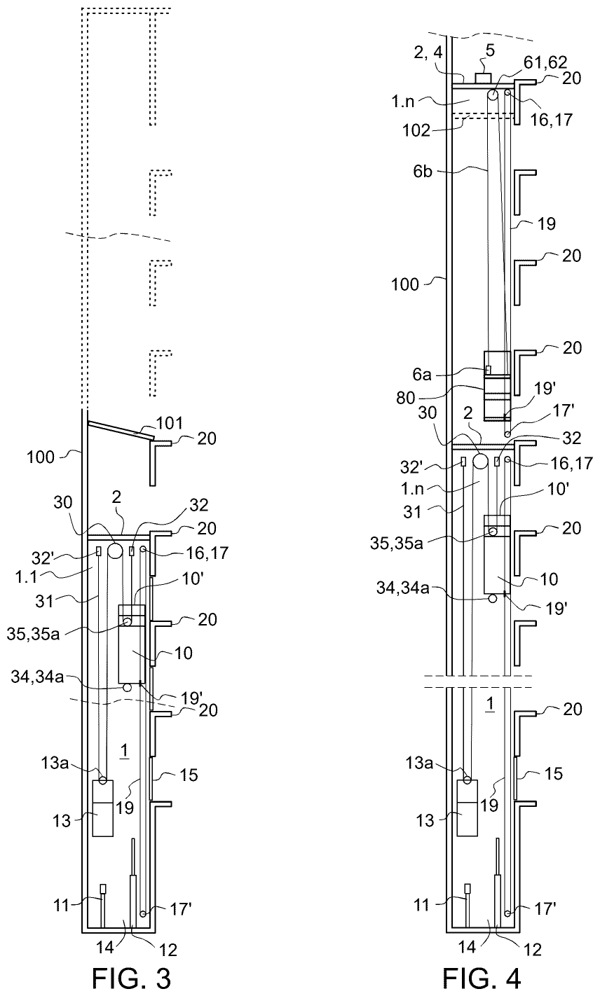

According to an embodiment, the elevator installation below the protection deck 2 is then completed for construction time use CTU. A hoisting machinery 30 and suspension ropes 31 are installed. According to an embodiment, the hoisting machinery 30 is hoisted close to the hoistway 1 wall 1a before installing the car guide rail 8. The car 10 and the counterweight 13 are supported by the suspension ropes 31 suspended by rope suspenders 32, 32′ and the elevator hoisting machine 30 so that the elevator can serve as construction time elevator. A temporary headroom 1.1 electrification is finalized in the uppermost part of the hoistway 1 below the protection deck 2. Thereafter the elevator is inspected and handed over for construction time use to serve at lower part of the building 100, as shown in FIG. 3.

According to an embodiment, the hoistway 1 may be extended by installing a further upper protection deck 2 or moving the protection deck 2 upwards in the hoistway 1, for example some landings 20 upwards, and continuing the installation in an upper hoistway section.

When the hoistway 1 under construction above the mounted hoisting machinery 30 has reached a sufficient stage of completion, the almost completed portion of the hoistway can be taken into use. At this stage a jump is performed, wherein the hoisting machinery 30 is hoisted higher in the hoistway. According to an embodiment, the hoisting machinery 30 is moved to the top of the freshly installed hoistway section to be taken into construction time use. After the jump, the car 10 can reach a higher position than before the jump and start to serve additional floors.

According to an embodiment, as a preparation for an elevator jump to an upper hoistway section, the man riding hoist 6a hoisting point 61 is moved to the upwards disposed protection deck 2 in the hoistway 1 as shown in FIG. 4.

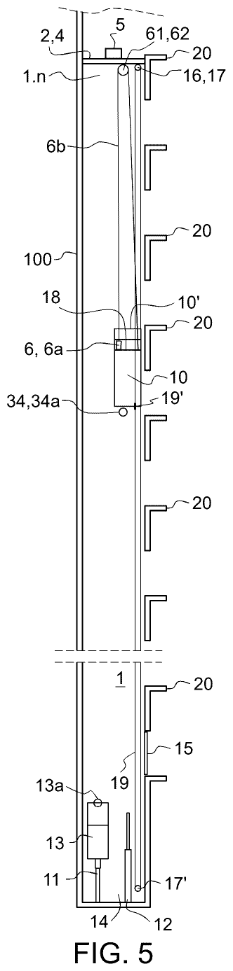

According to an embodiment, the extending installation in the upper hoistway section is implemented using as the installation platform the car 10 supported by the protection deck 2, as shown in FIG. 5.

According to an embodiment, the extending installation in the upper hoistway section is implemented using as the installation platform the working platform 80 supported by the protection deck 2, as shown in FIG. 4.

The elevator construction arrangement comprises a high friction coated suspension roping 31 arranged to suspend the car 10 and the counterweight 13 during construction time use.

According to an embodiment, the high friction coated suspension roping 31 comprises a smaller bending/folding radius than a suspension roping without a high friction coating.

According to an embodiment, the high friction coated suspension roping 31 is adapted to bend/fold around folding pulleys 35a with a smaller or reduced diameter compared to folding pulleys used with a suspension roping without a high friction coating.

According to an embodiment, the high friction coated suspension roping 31 comprises a smaller thickness in direction of the radius of the folding pulley 35a having a reduced diameter than a suspension roping without a high friction coating.

According to an embodiment, the configuration of the folding pulleys 35a having a reduced diameter on top 18 of the car provides for a safety clearance between the car 10 and wall 1a of the hoistway 1, preferably without need of safety rails on the car roof 18.

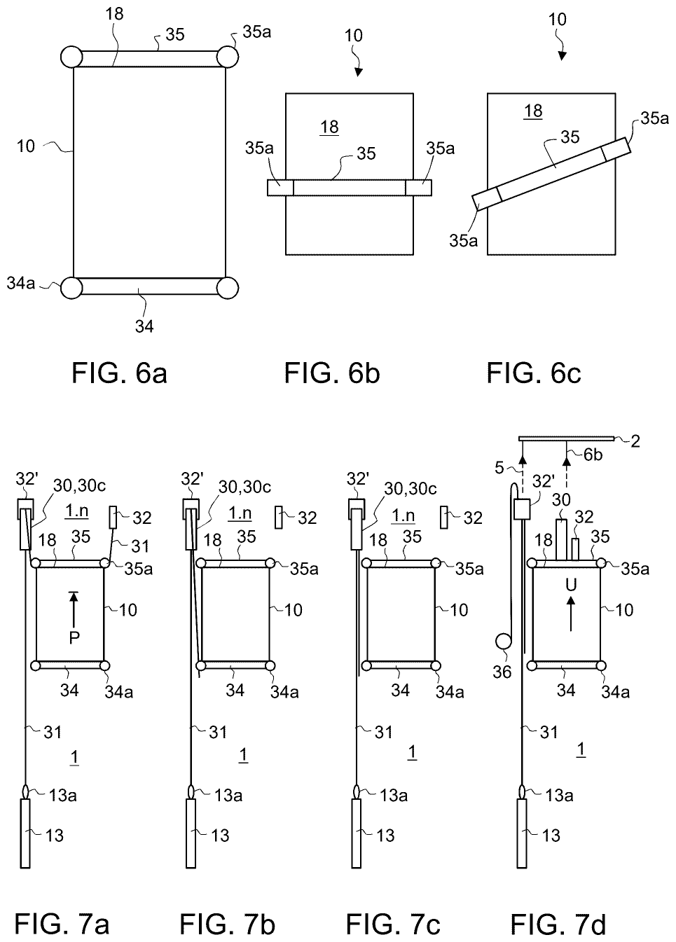

FIGS. 6a-6c show two embodiments of an elevator car 10 equipped with a first pulley beam 35 on top of the car 10.

The first folding pulley beam may also be called a CTU folding pulley beam 35 since it is used during construction of the building 100.

FIG. 6a shows a side view of the car 10 is provided on roof 18 with a first folding pulley beam 35 with first folding pulleys 35a for the suspension roping 31 preferably at ends of the first folding pulley beam 35.

According to an embodiment, the at least one first folding pulley beam 35 is mounted on the roof 18 of the car 10. According to an embodiment, the at least one first folding pulley beam 35 is mounted on the car sling 10a top beam.

According to an embodiment, a parallel first folding pulley beam 35 is installed on the roof 18 of the car 10, parallel with a side of the car, as shown in a top view in FIG. 6b.

According to an embodiment, a skewed first folding pulley beam 35 is installed on the roof 18 of the car 10, inclined with respect to the side of the car, as shown in a top view in FIG. 6c.

According to an embodiment, a bottom second folding pulley beam 34 with second folding pulleys 34a at its ends is installed to the car 10 bottom, particularly to the sling 10a bottom beam, prior to inspection of the elevator for final elevator use transporting people and goods.

FIGS. 7a-7d show, in connection of a jump, an exemplary temporary headroom 1.n installed in a hoistway 1. A hoist rope 6b supports the car 10 to be jumped upwards.

According to an embodiment, the hoisting machinery 30 is installed to the car guide rail to be supported by the car guide rail. The hoisting machinery 30 may be a construction time elevator hoisting machinery or a final hoisting machinery to be finally installed in the headroom in the top section of the hoistway 1 after the uppermost elevator jump.

In FIG. 7a a suspension roping 31 for the elevator car 10 and a counterweight 13 is shown when the elevator hoisting machine is supported by the car guide rail.

The suspension ropes 31 pass from a first rope suspender 32 downwards to a first folding pulley 35a and horizontally to another first folding pulley 35a.

According to an embodiment, the first folding pulleys 35a are positioned at the ends of the first folding pulley beam 35 on the roof 18 of the car.

According to an embodiment, the first folding pulley beam 35 extends across a sling top beam of the car 10.

The suspension roping 31 passes after the second first folding pulley 35a upwards to a drive wheel or a traction sheave 30c of the hoisting machinery 30 and further downwards to at least one pulley 13a of the CWT 13. The suspension roping 31 passes after the at least one CWT pulley 13a upwards to a second rope suspender 32′. The counterweight 13 is hanging from the at least one counterweight pulley 13a.

According to an embodiment, the arrangement comprises a roping supply storage 36 such as a rope reel 36 to deliver the roping 31 to the second rope suspender 32′, preferably when the travel of the car 10 is extended.

According to an embodiment, the roping 31 passes to the roping supply storage 36 after the second rope suspender 32′, for extending the travel of the car 10.

According to an embodiment, the second rope suspender 32′ comprises a rope locking anchor enabling running of the roping 31 through the second rope suspender.

In the following, preferred steps of a method for installing an elevator during construction of a building are presented.

In FIG. 7a, in preparation for the elevator jump to an upper floor 20, the car 10 is parked according to an arrow P on a predefined level so that the technician has access to the machinery 30 and the rope suspenders 32, 32′ from the car roof 18. The CWT 13 has been driven onto a support.

A hoist 6, 6a is installed on the car 10 to lighten the car to take the weight off the roping 31. The roping 31 is locked from the motor CWT side with a rope clamp and the clamp is attached to the second rope suspender 32′ e.g. with a chain that acts as a suspender on the CWT side of the machinery.

In FIG. 7b, the roping 31 has been disconnected from the first rope suspender 32 and slid off the first folding pulleys 35a on the roof 18 of the car 10.

The roping 31 is moved over the machinery 30 so that the ropes are on the CWT side as shown in FIG. 7c. The machinery 30 is detached and placed onto the car roof 18.

In FIG. 7d, the car 10 is moved upwards as shown with arrow U. The machinery 30, the first rope suspender 32 and optionally other headroom components such as overspeed governor equipment and headroom electrics are moved upwards with the car hoisted by the hoist 6, 6a, 6b and mounted to the jump upper position.

The second rope suspender 32′on the CWT side is opened. The second rope suspender 32′is lifted upwards by the material hoist 5, adding more roping 31. The second rope suspender 32′is installed in the new position and locked. The roping 31 to the second rope suspender 32′is delivered from the roping supply storage 36.

Now the ends of the ropes 31 can be moved back over the machinery 30 and roped through the first folding wheels 35a on the car roof 18 and attached to the first rope suspender 32 mounted in the upper new position.

It will be obvious to a person skilled in the art that, as the technology advances, the inventive concept can be implemented in various ways. The invention and its embodiments are not limited to the examples described above but may vary within the scope of the claims.

1. An elevator construction arrangement comprises
a hoistway,
an elevator car, a counterweight, car guide rails for guiding the car, and counterweight guide rails for guiding the counterweight,
an elevator hoisting machinery and a high friction coated suspension roping mounted on first and second rope suspenders and arranged to suspend the car and the counterweight during construction time use,
a protection deck mounted within the hoistway during an elevator jump operation in the hoistway,
a hoist device configured to move the car or at least parts of the car below the protection deck, the car being guided on the car guide rails, wherein
the arrangement comprises, arranged on top of the car, a first folding pulley beam with first folding pulleys having a small or reduced diameter, and
a smaller bending radius of the high friction coated suspension roping is adapted to cooperate with the small or reduced diameter of the first folding pulleys.

2. The arrangement according to claim 1, wherein the first folding pulley beam is mounted on the roof of the car.

3. The arrangement according to claim 1, wherein the first folding pulley beam is mounted on a car sling, preferably on a car sling top beam.

4. The arrangement according to claim 1, wherein a parallel first folding pulley beam is installed on the roof of the car, parallel with respect to a side of the car.

5. The arrangement according to claim 1, wherein a skewed first folding pulley beam is installed on the roof of the car, inclined with respect to a side of the car.

6. The arrangement according to claim 1, wherein the first folding pulleys are arranged at ends of the first folding pulley beam.

7. The arrangement according to claim 1, wherein the first folding pulley beam is a construction time use CTU pulley beam.

8. The arrangement according to claim 1, wherein the high friction coated suspension roping comprises PU-coated ropes or PU-coated belts.

9. The arrangement according to claim 1, wherein the high friction coated suspension roping comprises car support means having a rectangular or a circular cross section.

10. The arrangement according to claim 1, wherein the high friction coated suspension roping comprises a smaller bending/folding radius than a suspension roping without a high friction coating.

11. The arrangement according to claim 1, wherein the high friction coated suspension roping is adapted to bend/fold around first folding pulleys with a smaller or reduced diameter compared to folding pulleys used with a suspension roping without a high friction coating.

12. The arrangement according to claim 1, wherein the high friction coated suspension roping comprises a smaller thickness in direction of the radius of a first folding pulley having a reduced diameter than a suspension roping without a high friction coating.

13. The arrangement according to claim 1, wherein the configuration of the first folding pulleys having a small or reduced diameter on top of the car provides for a safety clearance between the car and the wall of the hoistway, preferably without need of safety rails on top of the car.

14. The arrangement according to claim 1, wherein a bottom second folding pulley beam with second folding pulleys at its ends is installed to the car bottom prior to inspection of the elevator for final elevator use transporting people and goods.

15. The arrangement according to claim 1, wherein the second rope suspender comprises a rope locking anchor enabling running of the roping through the second rope suspender.

16. The arrangement according to claim 1, wherein the arrangement comprises a roping supply storage such as a rope reel to deliver the roping to the second rope suspender.

17. The arrangement according to claim 1, wherein as the elevator travel is extended, the jump comprises a hoisting operation
of the machinery on the roof of the car into a headroom in the hoistway; and/or
of the first rope suspender on the roof of the car into a headroom in the hoistway; and/or
of the second rope suspender by a material hoist arranged on the protection deck.

18. A method for installing an elevator during construction of a building in an arrangement according to claim 1, wherein the method comprises, in connection with an elevator jump,
arranging the high friction coated suspension roping via the first folding pulleys having a small or reduced diameter and arranged on top of the car.

19. The method according to claim 18, comprising parking the car on a predefined level in the hoistway so that a technician has access to the machinery and the rope suspenders from the car roof.

20. The method according to claim 18, comprising lightening the car by the hoist to take the weight off the roping.

21. The method according to claim 18, comprising locking the roping from the machinery CWT side with a rope clamp and attaching the clamp to the second rope suspender.

22. The method according to claim 21, comprising disconnecting the roping from the first rope suspender and sliding the roping off the first folding pulleys.

23. The method according to claim 22, comprising moving the roping over the machinery so that the ropes are on the counterweight side.

24. The method according to claim 18, comprising
moving the machinery on the roof of the car into a headroom in the hoistway; and/or
moving the first rope suspender on the roof of the car into a headroom in the hoistway; and/or
moving the second rope suspender by a material hoist arranged on the protection deck.

25. The method according to claim 18, comprising placing the counterweight onto a support during the jump.

26. The method according to claim 18, comprising moving the car by the hoist device supported by the protection deck.

27. The method according to claim 18, comprising arranging the roping via second folding pulleys installed to the car bottom prior to inspection of the elevator for final elevator use transporting people and goods.
